(19) United States
(12) Patent Application Publication
(10) Pub. No.: US 2004/0245286 A1
(43) Pub. Date: Dec. 9, 2004

(54) Spout assembly

(76) Inventor: Jung Min Lee, Youngdungpo-gu (KR)

Correspondence Address: Norris McLaughlin & Marcus, 30th Floor, 220 East 42nd Street, New York, NY, 10017, US

(21) Appl. No.: 10/489,558

(22) PCT Filed: Sep. 10, 2002
(86) PCT No.: PCT/KR02/01699

(30) Foreign Application Priority Data
Sep. 10, 2001 (KR) 2001-0056618
Sep. 10, 2001 (KR) 2001-0056619
Aug. 27, 2002 (KR) 2002-0052184
Aug. 30, 2002 (KR) 2002-0052639
Aug. 30, 2002 (KR) 2002-0052640

(51) Int. Cl. B67D 5/00

(52) U.S. Cl. 222/83

(57) ABSTRACT

A spout assembly includes a spout sealing portion coupled on a container sealing portion, a spouting portion formed on the spouting sealing portion and extending upward, a closure for closing the spouting portion, the closure being connected to the spouting portion by a connecting member, and a closure location maintaining member for, when the closure is opened, maintaining the closure at a location where the closure does not obstruct the flow of contents discharged through the spouting portion.

### TECHNICAL FIELD

The present invention relates to a spout assembly and, more particularly, to a spout assembly that is designed having a closure that can be maintained, when it is opened, at a location where it does not obstruct the flow of the contents discharged out of the spouting portion.

The present invention further relates to a spout assembly is designed to be easily located on a pouch sealing portion.

### BACKGROUND ART

Generally, a spout assembly used for a container utilized for discharging the contents little by little many times is designed having a closure integrally formed with a main body of the spout. When the closure is opened from the main body, the closure is still not removed from the main body, but connected to the main body.

However, since the closure is connected to the main body by a thin strip member, the closure gets to locate on the outlet of the spout assembly during the course of pouring the contents out of the container after opening the closure.

In the conventional spout assembly for a pouch container, the sealing portion is sealed between films of the pouch container. However, when locating the spout seal portion on a pouch seal portion defined between the films of the pouch container, the pouch films may be damaged due to the confliction between the spout seal portion and the films. In addition, since there is no guide means, it is difficult to easily locate the spout seal portion on the pouch seal portion, deteriorating the productivity.

### DISCLOSURE OF INVENTION

Therefore, the present invention has been made in an effort to solve the above-described problems of the prior art.

It is a first objective of the present invention to provide a spout assembly that is designed having a closure that can be maintained, when it is opened, at a location where it does not obstruct the flow of the contents discharged out of the container through a pouring portion.

It is a second objective of the present invention to provide a spout assembly that is designed, when it is applied to a pouch container, not to damage the pouch film during the course of disposing a spout seal portion on a pouch seal portion defined between the films of the spout pouch, thereby improving the productivity and reducing the inferiority.

To achieve the above objectives, the present invention provides a spout assembly

### BRIEF DESCRIPTION OF THE DRAWINGS

FIG. 1 is a perspective view of a spout assembly according to a first embodiment of the present invention;

FIG. 2 is a sectional view taken along line X-X of FIG. 1;

FIGS. 3 and 4 are views illustrating the use of a spout assembly according to the first embodiment of the present invention;

FIGS. 5 and 6 are views illustrating a spout assembly of the first embodiment, which is applied to a pouch container;

FIGS. 7 and 8 are front view of a spout assembly according to a second embodiment of the present invention;

FIG. 9 is a front view of a spout assembly according to a third embodiment of the present invention;

FIG. 10 is a front view of a spout assembly according to a fourth embodiment of the present invention;

FIG. 11 is a front view of a spout assembly according to a fifth embodiment of the present invention;

FIG. 12 is a front view of a spout assembly according to a sixth embodiment of the present invention;

FIG. 13 is a front view of a spout assembly according to a seventh embodiment of the present invention;

FIG. 14 is a front view of a spout assembly according to an eighth embodiment of the present invention;

FIG. 15 is a front view of a spout assembly according to a ninth embodiment of the present invention;

FIG. 16 is a front view of a spout assembly according to a tenth embodiment of the present invention;

FIG. 17 is a front view of a spout assembly according to an eleventh embodiment of the present invention;

FIG. 18 is a front view of a spout assembly according to a twelfth embodiment of the present invention;

FIG. 19 is a front view of a spout assembly according to a thirteenth embodiment of the present invention;

FIG. 20 is a front view of a spout assembly according to a fourteenth embodiment of the present invention;

FIG. 21 is a front view of a spout assembly according to a fifteenth embodiment of the present invention;

FIG. 22 is a front view of a spout assembly according to a sixteenth embodiment of the present invention;

FIG. 23 is a front view of a spout assembly according to a seventeenth embodiment of the present invention;

FIG. 24 is a front view of a spout assembly according to an eighteenth embodiment of the present invention;

FIG. 25 is a front view of a spout assembly according to a nineteenth embodiment of the present invention;

FIG. 26 is a front view of a spout assembly according to a twentieth embodiment of the present invention;

FIG. 27 is a front view of a spout assembly according to a twenty-first embodiment of the present invention;

FIG. 28 is a front view of a spout assembly according to a twenty-second embodiment of the present invention;

FIG. 29 is a front view of a spout assembly according to a twenty-third embodiment of the present invention;

FIG. 30 is a front view of a spout assembly according to a twenty-fourth embodiment of the present invention;

FIG. 31 is a front view of a spout assembly according to a twenty-fifth embodiment of the present invention;

FIGS. 32 and 33 are front views of a spout assembly according to a twenty-sixth embodiment of the present invention;

FIGS. 34 and 35 are front views of a spout assembly according to a twenty-seventh embodiment of the present invention;

FIGS. 36 and 37 are front views of a spout assembly according to a twenty-eighth embodiment of the present invention;

FIGS. 38 and 39 are front views of a spout assembly according to a twenty-ninth embodiment of the present invention; and

FIG. 40 is a front view of a spout assembly according to a thirtieth embodiment of the present invention.

### BEST MODE FOR CARRYING OUT THE INVENTION

Preferred embodiments of the present invention will be described more in detail hereinafter in conjunction with the accompanying drawings.

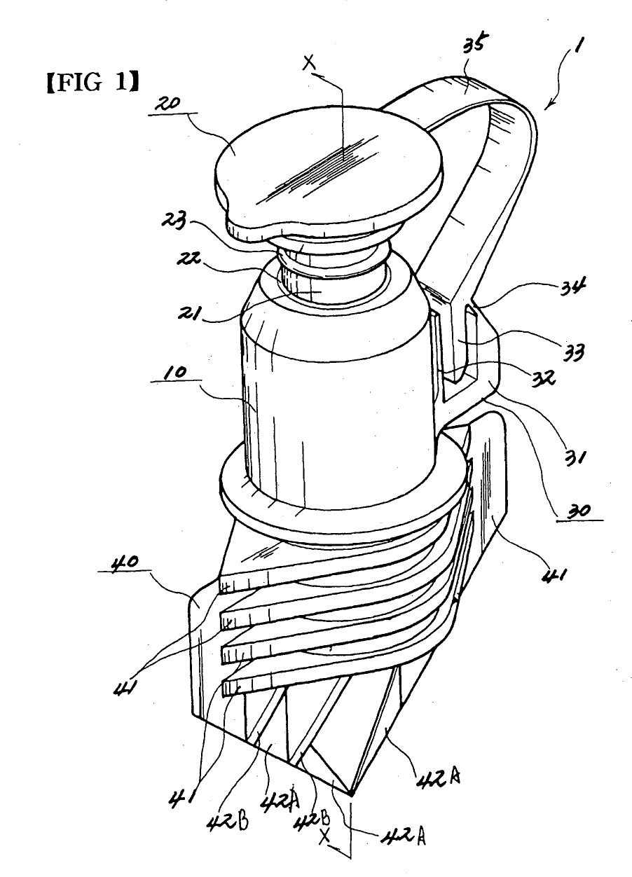

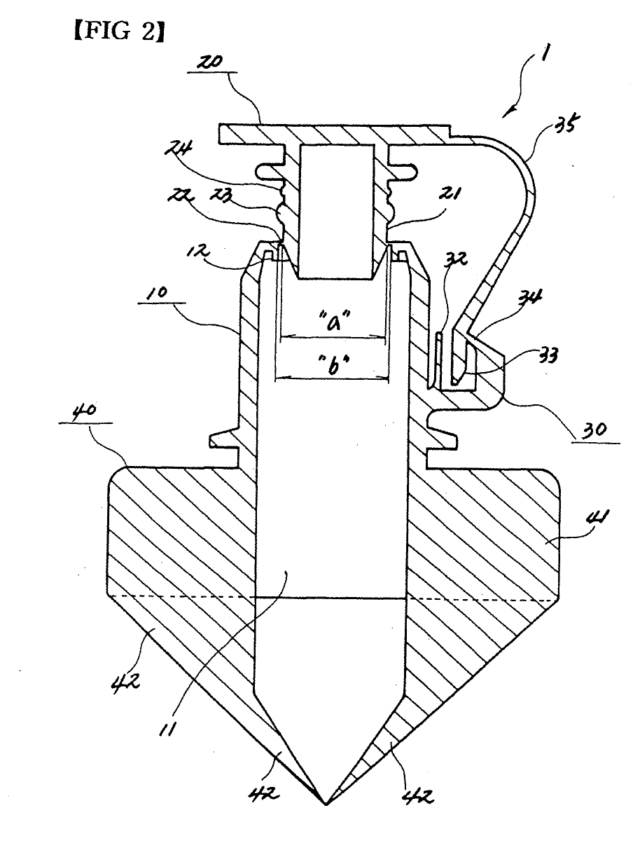

FIGS. 1 and 2 show a spout assembly according to a first embodiment of the present invention.

As shown in the drawings, the inventive spout assembly 1 of this embodiment comprises a spouting portion 10 provided with a fluid passage 11 and an elastic circumferential projection 12 extending from an inner circumference of its outlet end and further extending downward and a closure 20 integrally formed on the outlet end of the spouting portion 10 with a cutting-line 22 and provided with a cylindrical sealing wall 21. The cylindrical sealing wall 21 is provided at its outer circumference with a circumferential hook projection 23 and a circumferential seal projection 24.

A spout seal portion 40 that is sealed on a container seal portion is integrally formed on a bottom of the spouting portion 10. The spout seal portion 40 of this embodiment is for a pouch container. That is, the spout seal portion 40 comprises a main seal portion 41, a first locating guide portion 42A for guiding the location of opposite ends of the main seal portion 41 on a pouch seal portion defined between films of the pouch container, and a second locating guide portion 42B for guiding the location of the front/rear surfaces of the main seal portion 41 on the pouch seal portion. This will be described more in detail later on.

Meanwhile, a strip-shaped flexible connecting member 35 integrally connects the closure 20 to the spouting portion 10. After the closure 20 is broken away from the spouting portion 10 on the basis of the cutting line 22, when it is intended to pour the contents out of the container through the spouting portion 10, the closure is still located in front of the outlet end of the spouting portion 10, resulting in obstructing the flow of the contents discharged from the container. This causes the user to feel inconvenience.

To overcome this problem, the present invention provide closure location maintaining means 30 for maintaining the closure 20 at an open location where it does not obstruct of the flow of the contents discharged out of the container through the spouting portion,

In this embodiment, the closure location maintaining means 30 comprises a supporting portion 31 projected from an outer circumference of the spouting portion, on an upper end of which one end of the connecting member 35 is connected, a fixing projection 33 extending downward from the upper end of the supporting portion, and a supporting projection 32 extending upward from a base of the supporting portion 31.

Preferably, the closure 20 is designed such that an outer diameter of the circumferential seal projection is greater than an inner diameter of the elastic projection 12 formed on the outlet end of the spouting portion 10 to improve the seal effect.

In addition, as shown in FIG. 2, an outer diameter (a) of the sealing wall 21 is designed greater than an inner diameter of the elastic projection 12 so that the sealing wall 21 can be easily inserted into the spouting portion 10 over the elastic projection 12 when it is intended to reseal the opening of the spouting portion 10 using the closure 20 after the cutting line 22 is broken.

The operation effect of the present invention will be described hereinafter in conjunction with the accompanying drawings.

First, the function of the closure 20 and the spouting portion 10 coupled to the closure 20 will be described.

From a state shown in FIG. 2, when the closure 20 is twisted or bent in a direction, the cutting line 22 that is formed to be thin is broken, as a result of which the closure 20 is separated from the spouting portion 10.

At this point, the closure 20 is still connected to the spouting portion 10 by the connecting member 25.

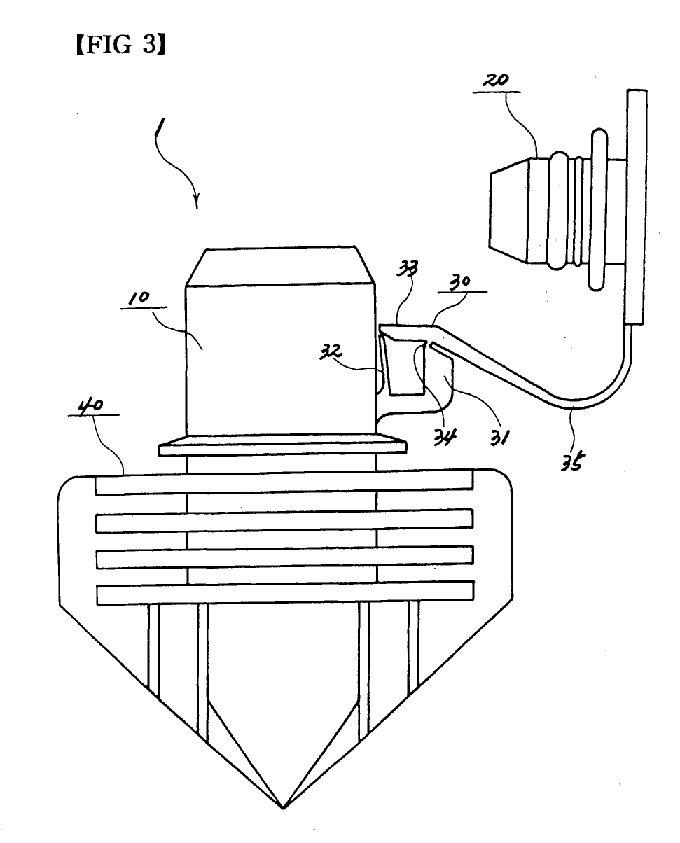

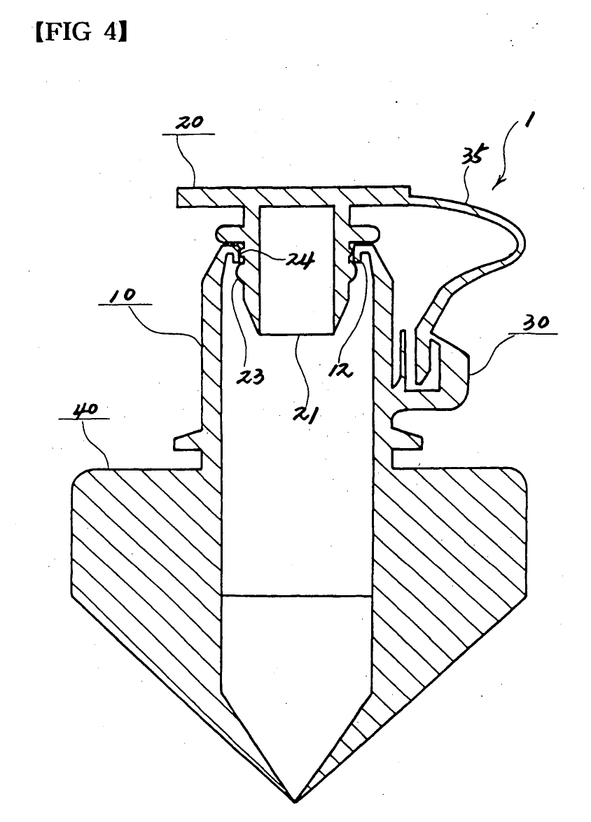

From this state, when the closure 20 is bent toward the connecting member 35, the fixing projection 33 moves upward while being rotated by the connecting member 34 and elastically goes over the projection 32 while pushing the projection, thereby being interlocked on the upper end of the projection 32 (see FIG. 3).

When it is assumed that the spout assembly 1 is associated with a container, when the container is inclined in a direction from the state shown in FIG. 3, the contents is poured out of the container through the fluid passage 11. At this point, since the closure 20 is maintained at a location away from the outlet of the spouting portion 10, the closure 20 does not obstruct the flow of the contents discharged out of the container through the spouting portion 10.

After the pouring the contents is finished, when the closure is pulled upward, the fixing projection 33 interlocked on the upper end of the projection 32 is returned to its initial position. Then, by inserting the sealing wall 21 is inserted into the spouting portion 10. At this point, since the outer diameter of the sealing wall 21 is less than the inner diameter of the elastic projection 12, the sealing wall 21 can be smoothly inserted into the spouting portion.

However, during the insertion process, when the circumferential hook projection 23 gets to the circumferential elastic projection 12, the sealing wall 21 is no more inserted.

At this point, when addition force is applied to the closure 20, the end of the fixing projection 33 goes over the projection 32 to interlock with the projection 32.

Even if the above operation is repeated many times, it works well.

That is, when it is intended to re-close the closure 20 into the spouting portion 10, since a below portion of the circumferential elastic projection 12 is formed in a circumferential space, the circumferential elastic projection 12 provides an elastic seal effect on the circumferential sealing projection 24 of the closure 20.

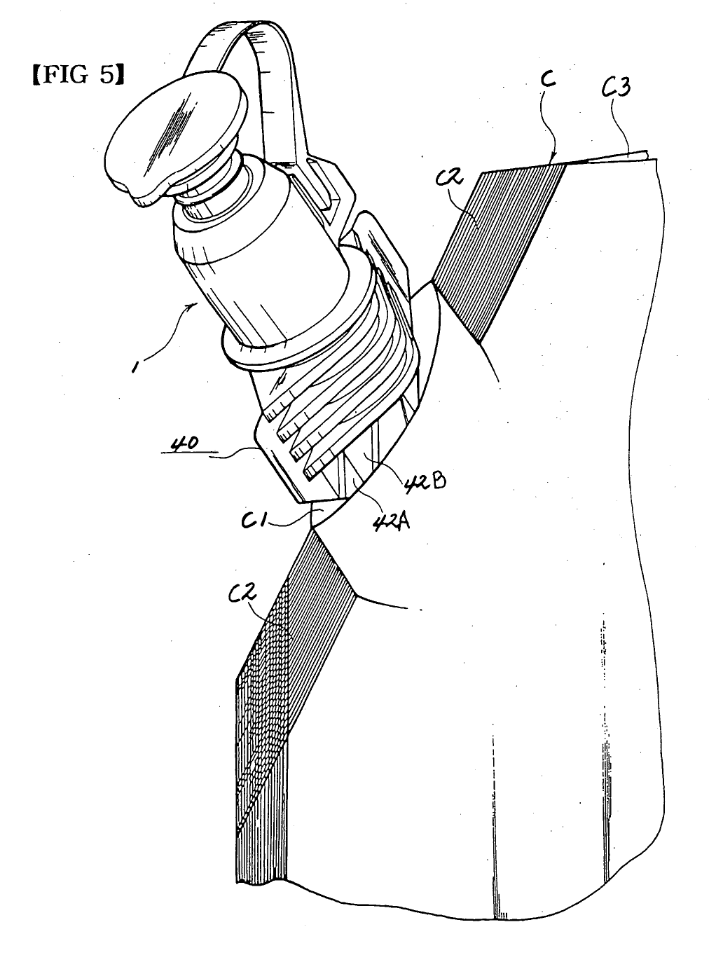

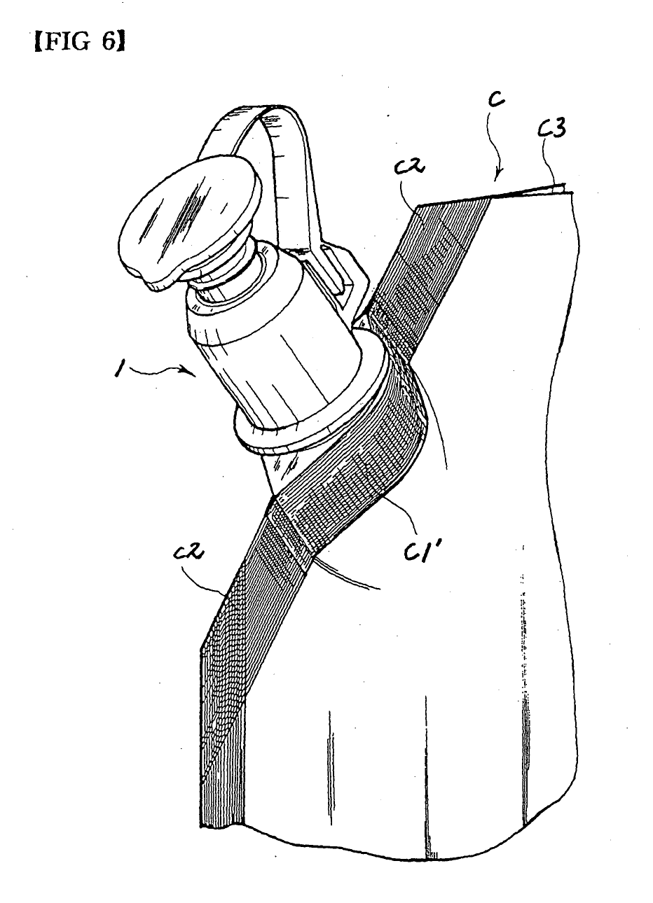

As shown in FIG. 5, during the course of locating the spout seal portion 40 of the spout assembly on a container seal portion C1 of the container, even when the spout seal portion 40 is inserted in a state where it is offset from the exact position of the container seal portion C1, the spout seal portion 40 can be smoothly located on the container seal portion C1 by the first and second locating guide portions 42A and 42B.

The second locating guide portion 42B is formed of plural ribs extending downward from the bottom of the spout seal portion 40 at a predetermined inclined angle. This has an advantage of saving the material. That is, when an overall shape of the second locating guide portion 42B is formed in a conical shape, more material is used.

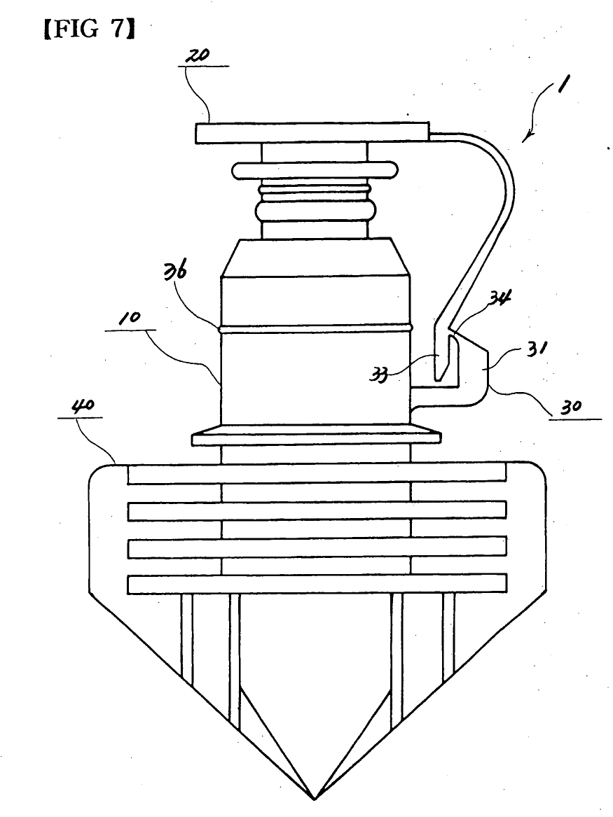

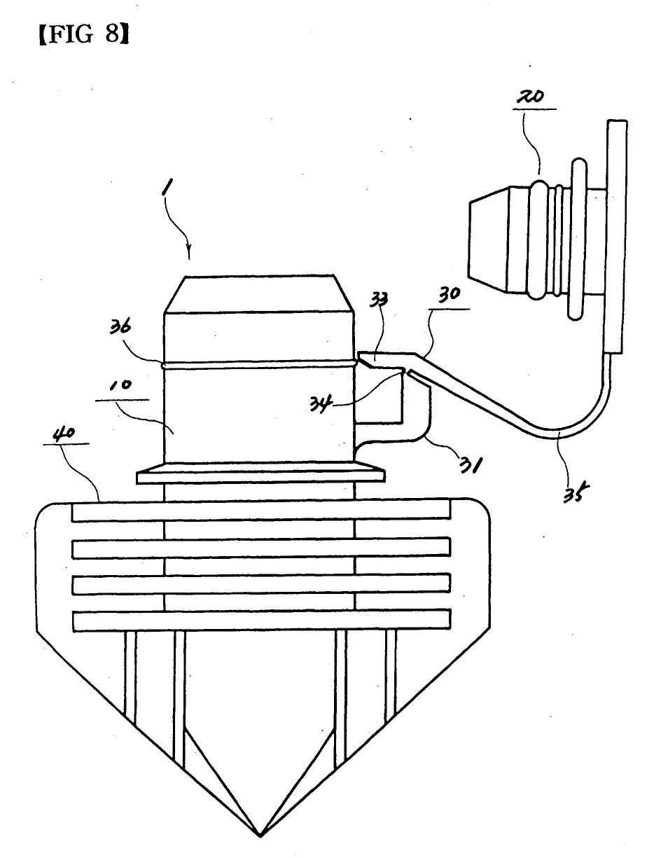

FIGS. 7 and 8 shows a second embodiment of the present invention. This embodiment is identical to the first embodiment except that the fixing projection 33 is designed to be interlocked with a circumferential projection 36 formed on the outer circumference of the spouting portion 10.

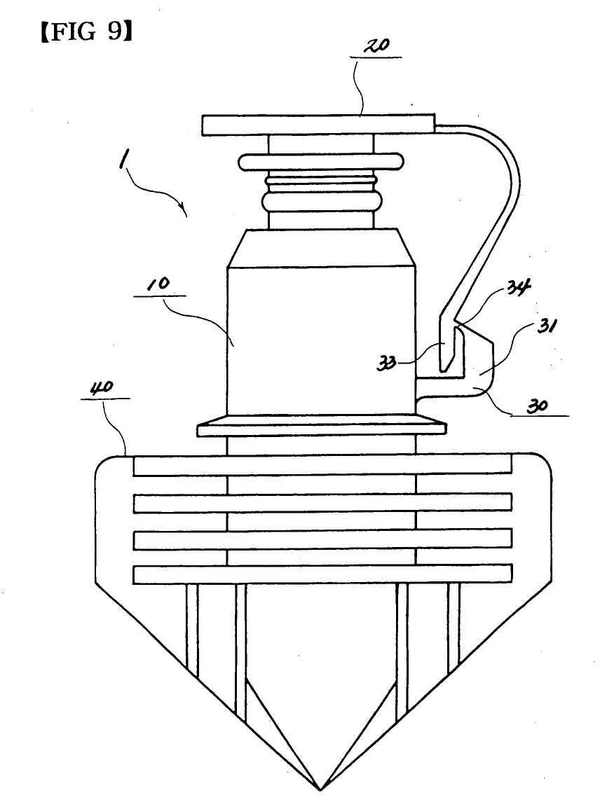

In a third embodiment of FIG. 9, the outer circumference of the spouting portion 10 can be designed to fix the fixing projection 33 by itself.

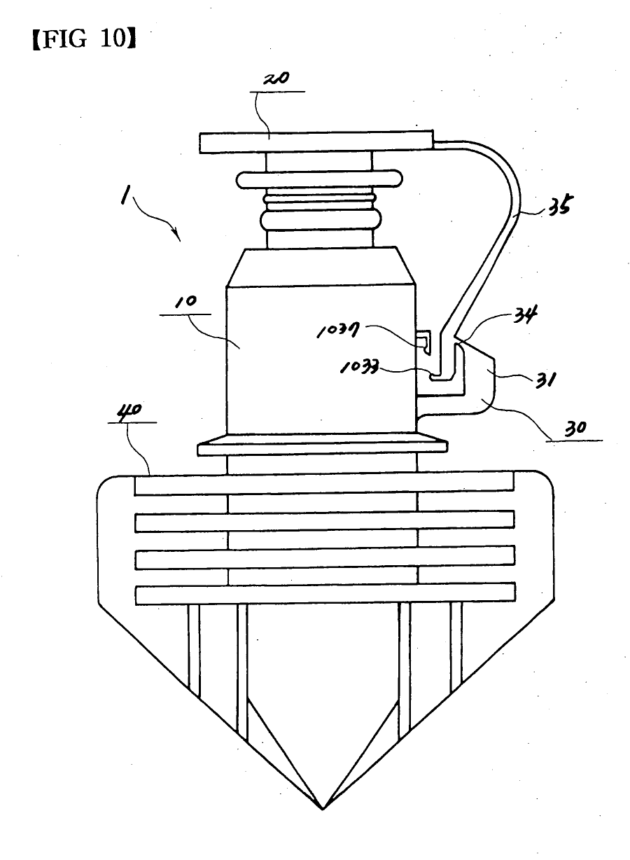

In a fourth embodiment of FIG. 10, a hook is formed on a free end of the fixing projection 1033 that is interlocked with a hook projection 1037 formed on the outer circumference of the spouting portion 10.

In use, the hook is interlocked by hooking on the hooking projection 1037.

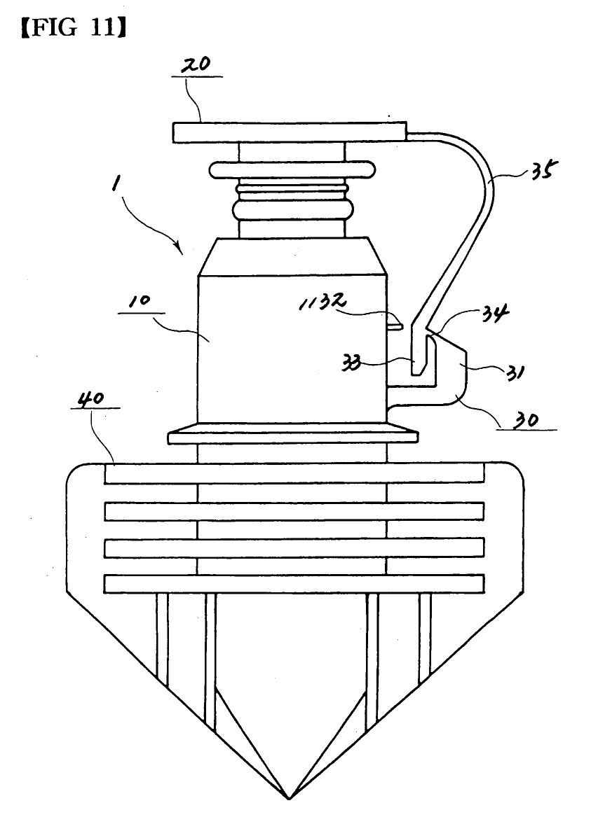

According to a fifth embodiment of FIG. 11, a projected piece 1132 on which the fixing projection 33 can elastically fixed by going over the projected piece.

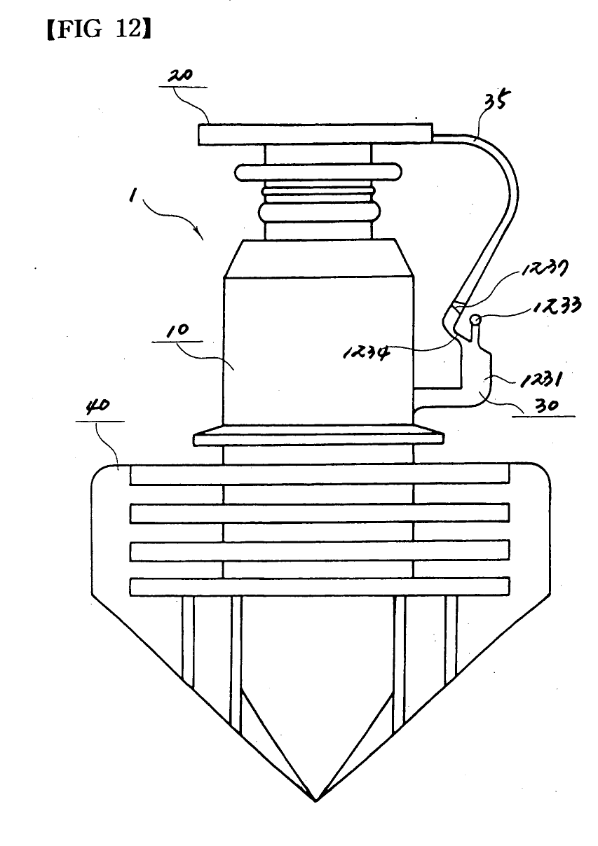

According to a sixth embodiment of FIG. 12, a fixing projection 1233 is projected upward on the supporting member 1231, and a coupling hole 1237 to which the fixing projection 1233 can be fixedly inserted is formed on the connecting member 35. The insertion state of the fixing projection 1233 into the coupling hole 1237 can be released by predetermined force.

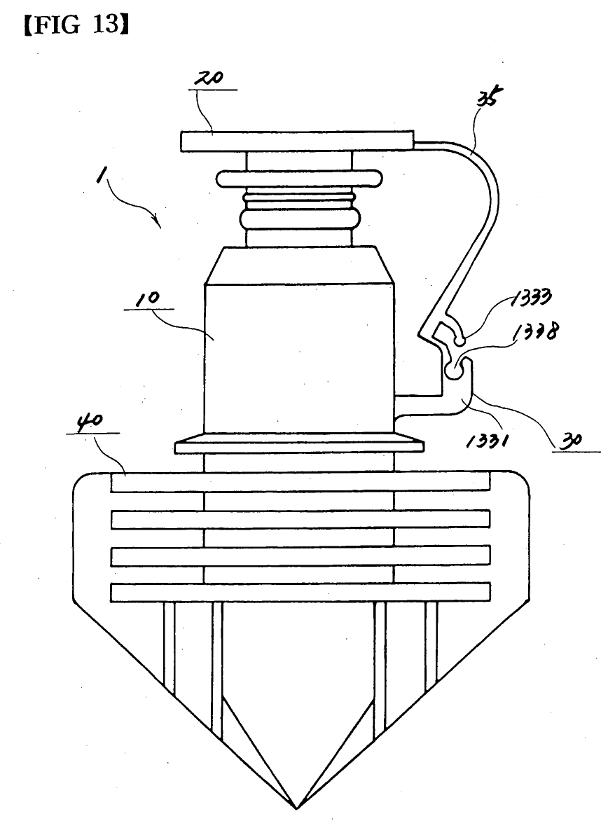

According to a seventh embodiment of FIG. 13, a coupling groove 1338 is formed on the supporting member 1331 and a fixing projection 1333 that can be fixedly inserted into the coupling groove 1338 is formed on the connecting member 35, which is fixedly inserted into the coupling groove 1338.

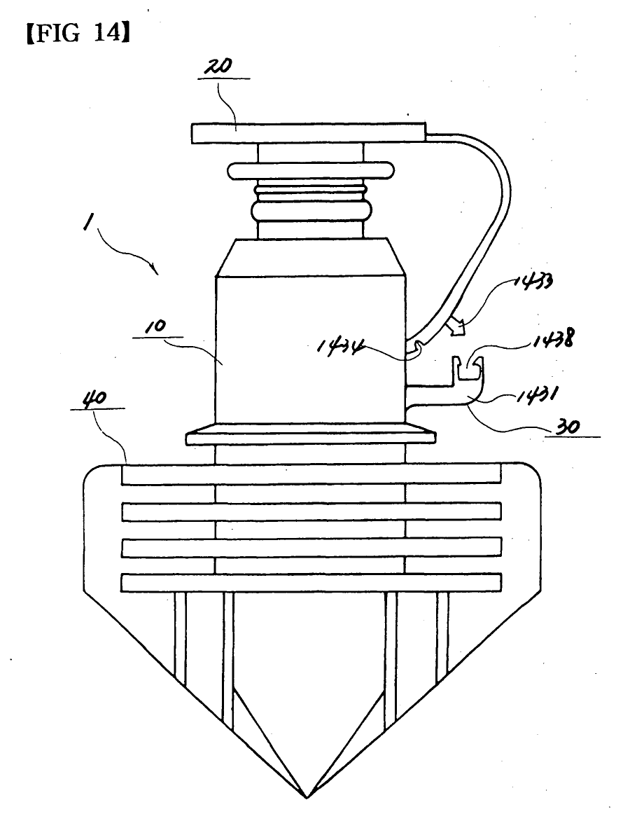

According to an eighth embodiment of FIG. 14, a coupling groove 1438 is formed on the supporting member 1431 and a fixing projection 1433 that can be fixedly inserted into the coupling groove 1438 is formed on the connecting member 35 that is coupled to the spouting portion 10 by a connecting portion 1434.

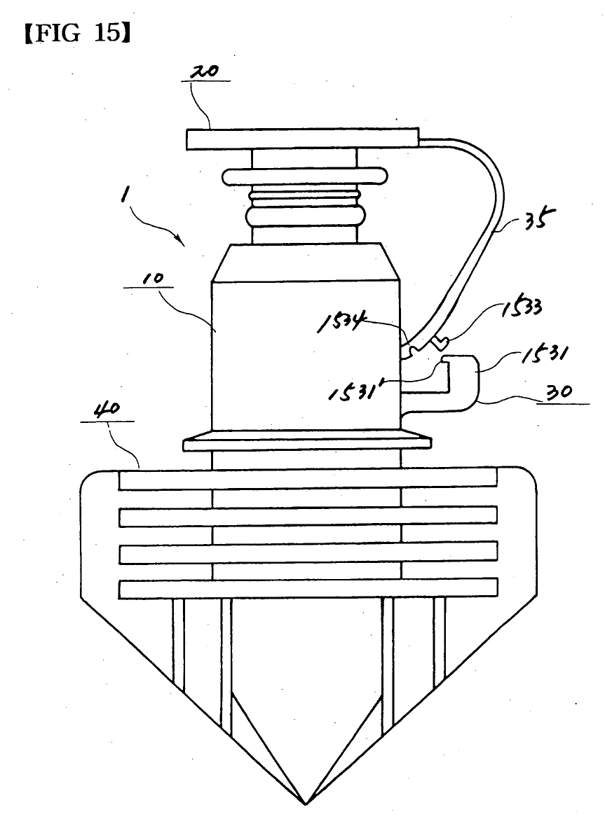

According to a ninth embodiment of FIG. 15, a hook projection 1531′ is formed on an upper end of the supporting member 1531 and a fixing projection is formed on the connecting member 35 that is coupled to the spouting portion 10 by a connecting portion 1534.

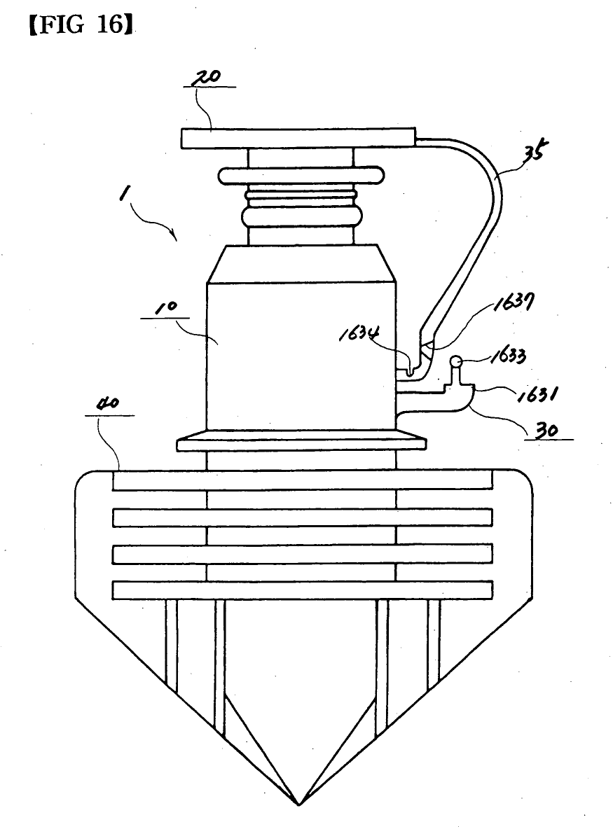

According to a tenth embodiment of FIG. 16, a fixing projection 1633 is formed on the supporting member 1631 and a coupling hole 1637 in which the fixing projection 1633 can be fixedly inserted is formed on the connecting member 35. The connecting member 35 is coupled to the spouting portion 10 by a connecting portion 1634. In use, the coupling hole 1637 is interlocked with the fixing projection 1633.

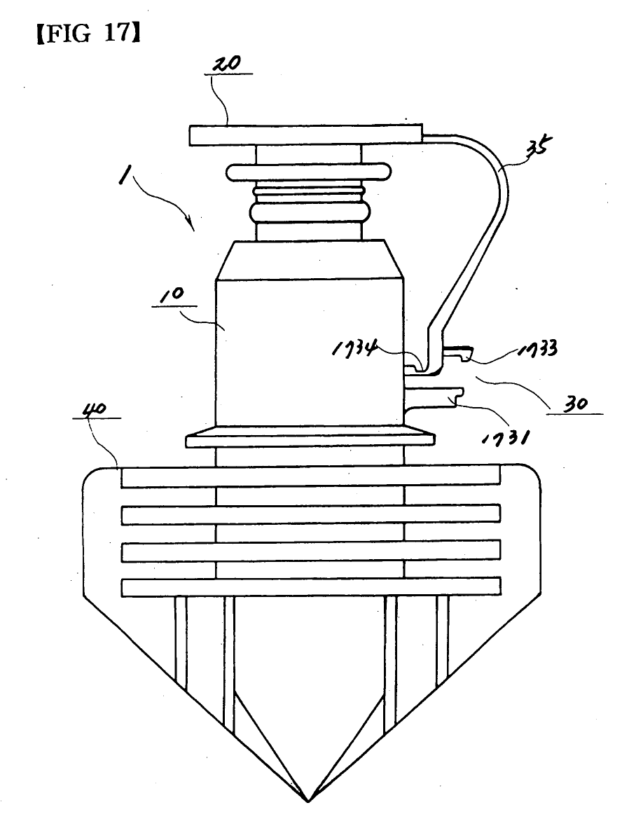

According to an eleventh embodiment of FIG. 17, the supporting member 1731 is designed having a step to which a fixing projection 1733 formed on the connecting member 35 can be interlocked. The connecting member 1731 is coupled to the spouting portion 10 by a connecting portion 1734.

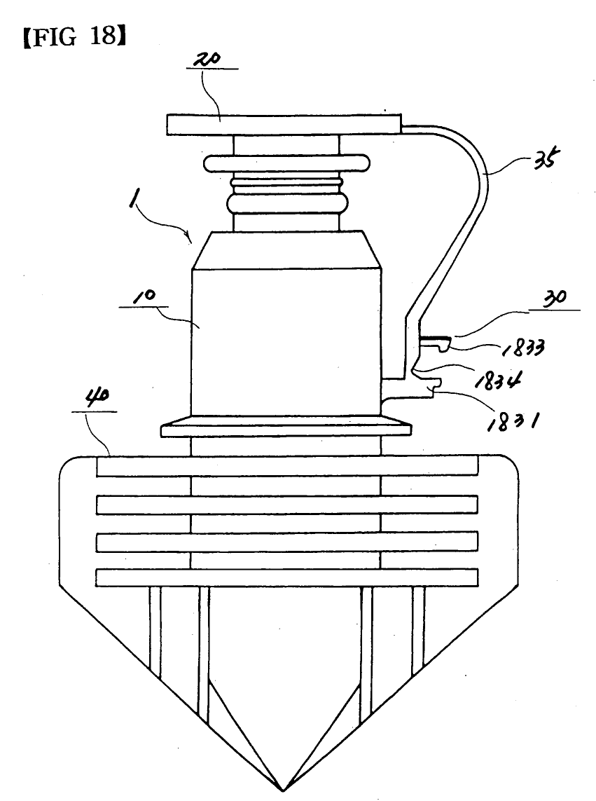

According to an twelfth embodiment of FIG. 18, the supporting member 1831 is designed having a step to which a fixing projection 1833 formed on the connecting member 35 can be interlocked. The connecting member 1731 is coupled to the supporting member 1831 by a connecting portion 1734.

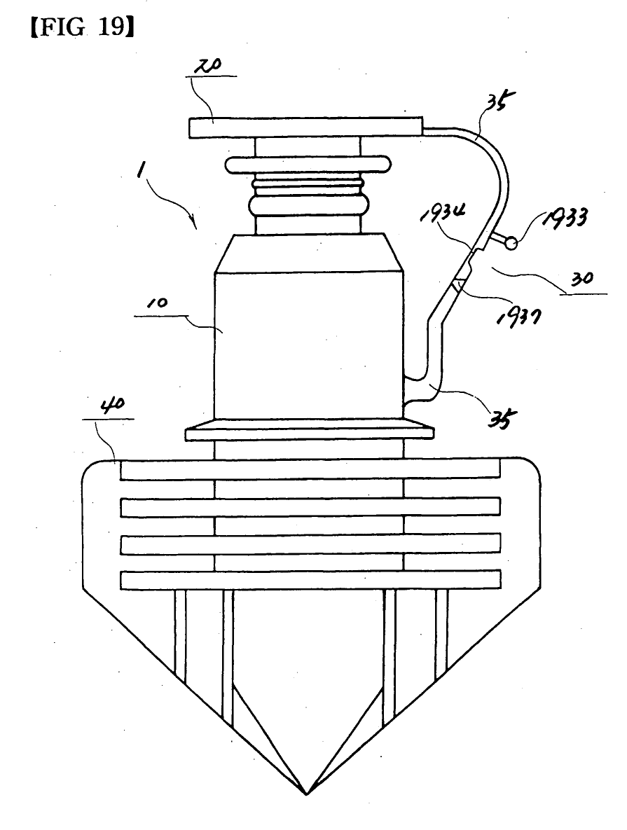

According to a thirteenth embodiment of FIG. 19, the closure location maintaining means can be formed on the connecting member 35 connecting the closure 20 to the spouting portion 10. A thin portion 194 is formed on the connecting member 35. A fixing projection 1933 and a coupling hole 1937 are respectively formed on the connecting member 35 at both sides of the thin portion 1934. In use, the fixing projection 1933 is fixedly fitted into the couple hole 1937.

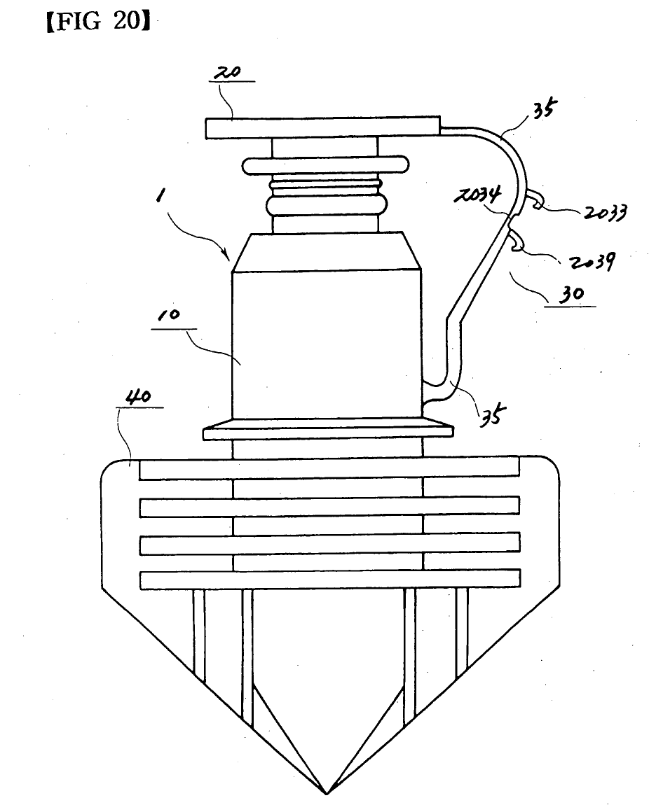

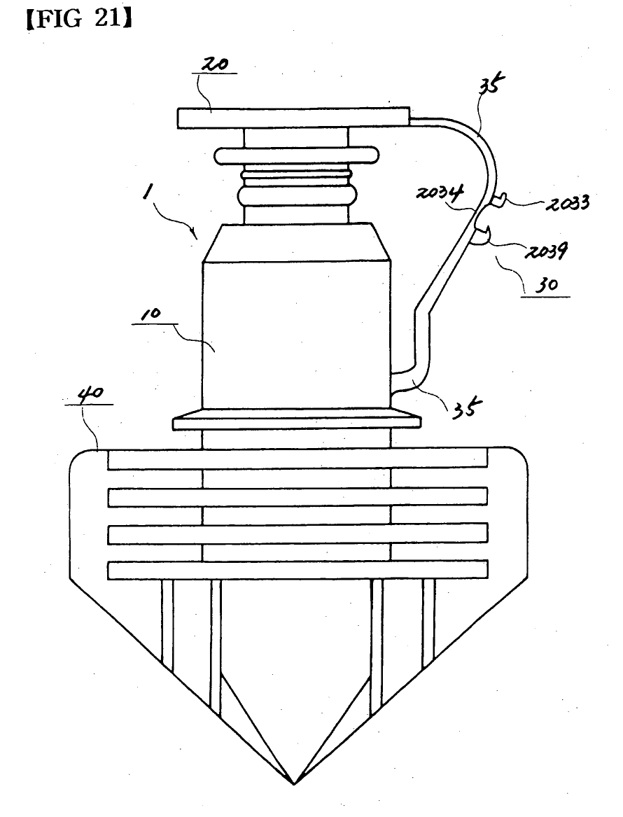

According to a fourteen embodiment of FIG. 20, two interlocking projections 2033 and 2039 are formed on the connecting member 35 at both sides of a foldable thin portion 2034. In use, the interlocking projections 2033 and 2039 are interlocked with each other. (FIG. 21 shows an identical to the fourteen embodiment except for the directions of the projections.)

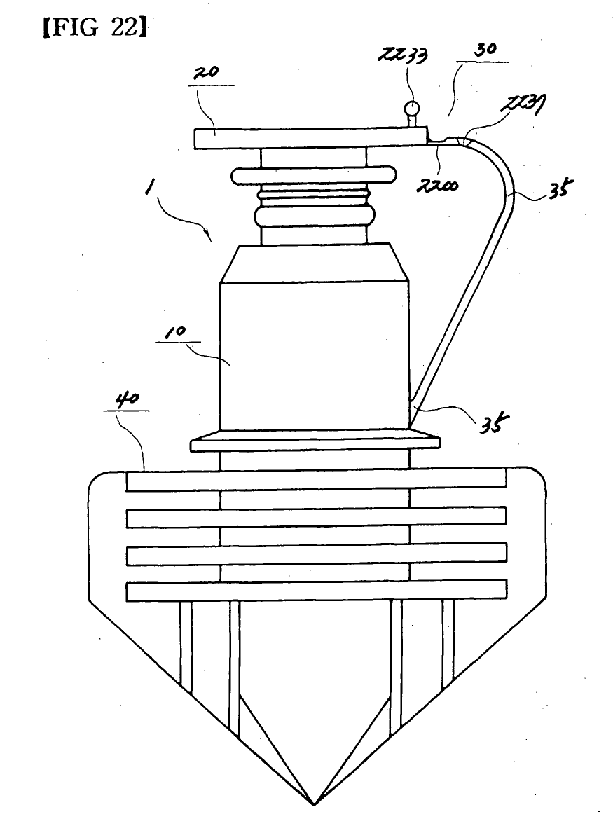

According to a sixteenth embodiment of FIG. 22, a fixing projection 2233 are formed on the top of the closure 20 and a coupled hole 2237 are formed on the connecting member 35. A foldable thin portion 2200 is formed on the connecting member 35 between the projection 223 and the coupling hole 2237.

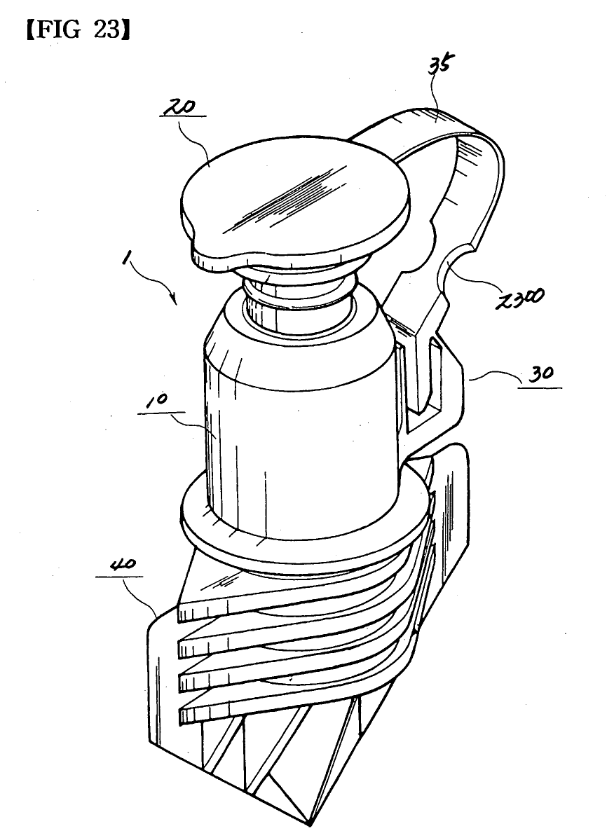

According to a seventeenth embodiment of FIG. 23, a direction change portion 2300 is formed on the connecting member 35 so that the connecting member 35 can be more freely moved during the course of removing the closure 20 from the spouting portion 10.

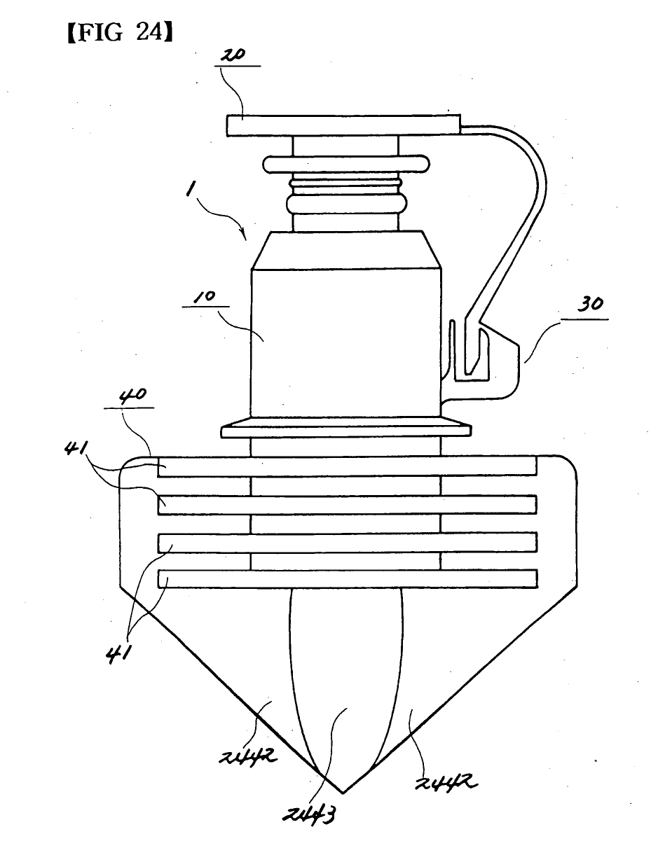

According to an eighteenth embodiment of FIG. 24, a space 2443 is formed on the locating guide portion 2442 below the spout seal portion 41.

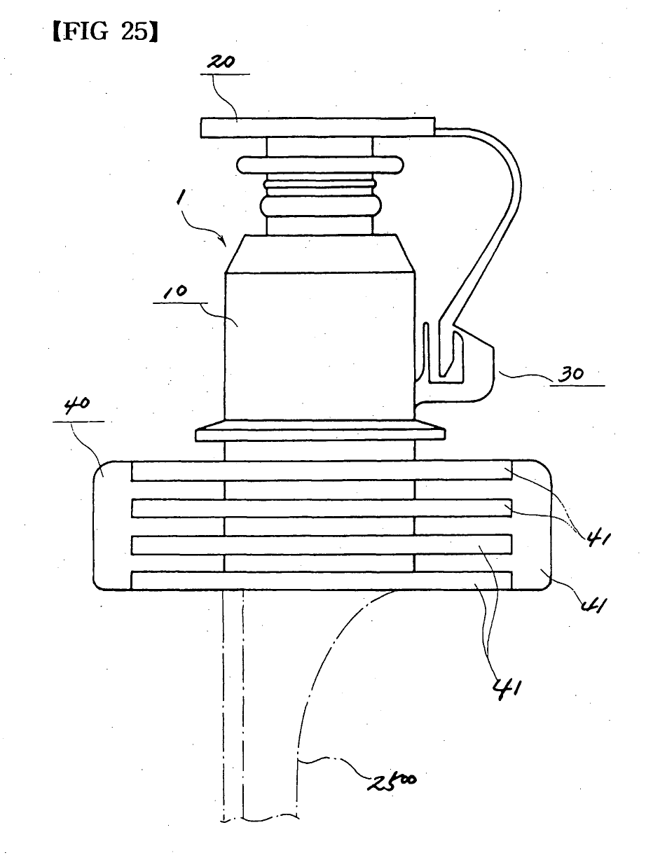

According to an nineteenth embodiment of FIG. 25, the spout seal portion 40 is provided with an attaching surface 41 so that the spout assembly can be associated with a variety of containers.

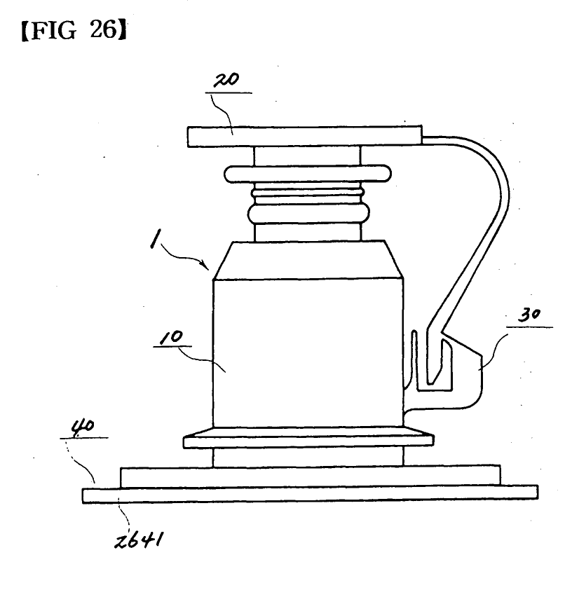

According to a twentieth embodiment of FIG. 26, the spout seal portion 40 is designed to coupled on a surface of a container. That is, the spout seal portion 40 is provided with a circular hoop attaching surface 2641.

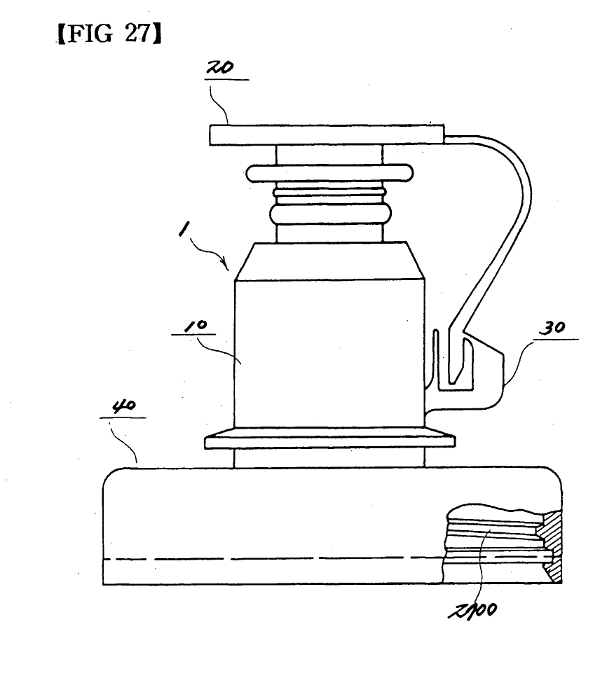

According to a twenty-first embodiment of FIG. 27, the spout sealing portion is formed in a cap-type provided with a screw thread 2700 so that it can be screw-coupled to a neck of a container.

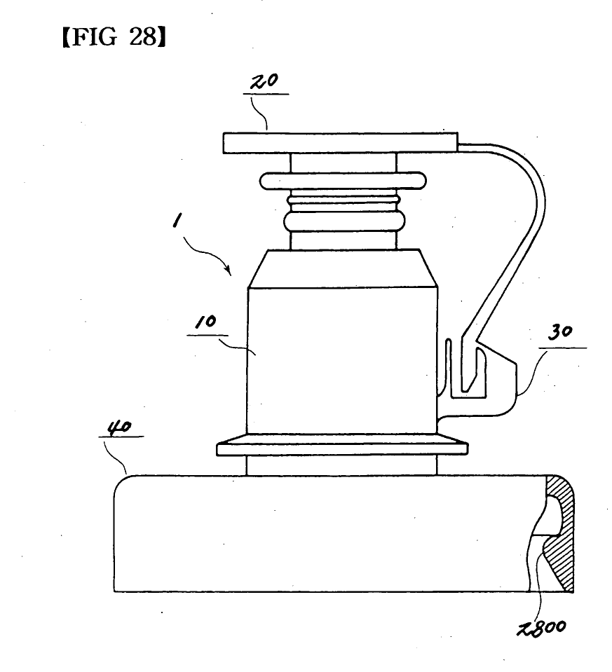

According to a twenty-second embodiment of FIG. 28, the spout seal portion is formed in a cap-type provided with a hook projection 2800 so that it can fitted on a neck of a container in a one-touch manner.

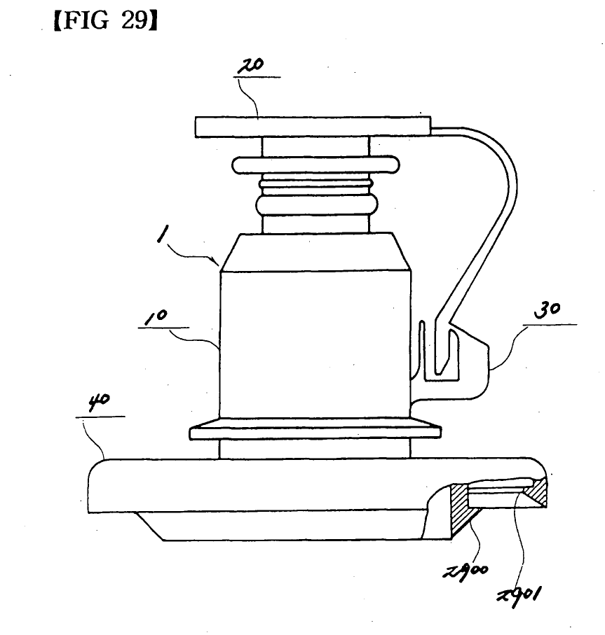

According to a twenty-third embodiment of FIG. 29, the spout seal portion 40 is formed in a cap-type provided with a hook projections 2900 and 2901 so that it can be elastically inserted around a container neck.

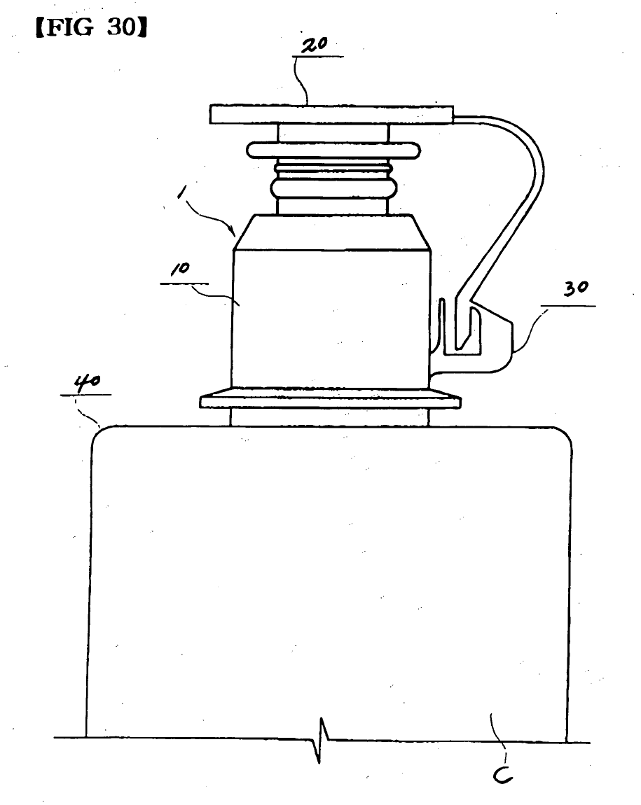

According to a twenty-fourth embodiment of FIG. 30, the spout seal portion 40 is integrally formed on a container body C.

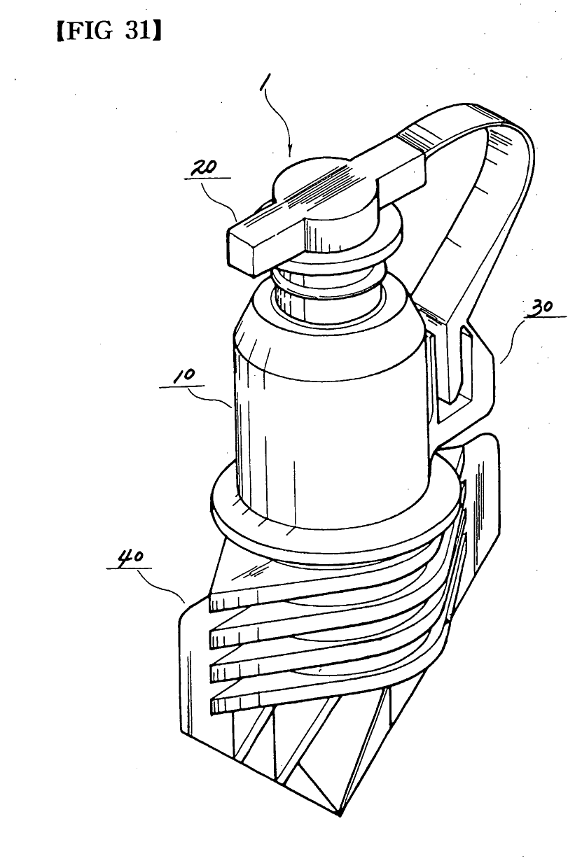

According to a twenty-fifth embodiment of FIG. 31, an upper end of the closure 20 is formed in a tap shape so as to provide the more convenience in breaking the closure 40 from the spouting portion 10 and re-closing the closure 40 in the spouting portion 10.

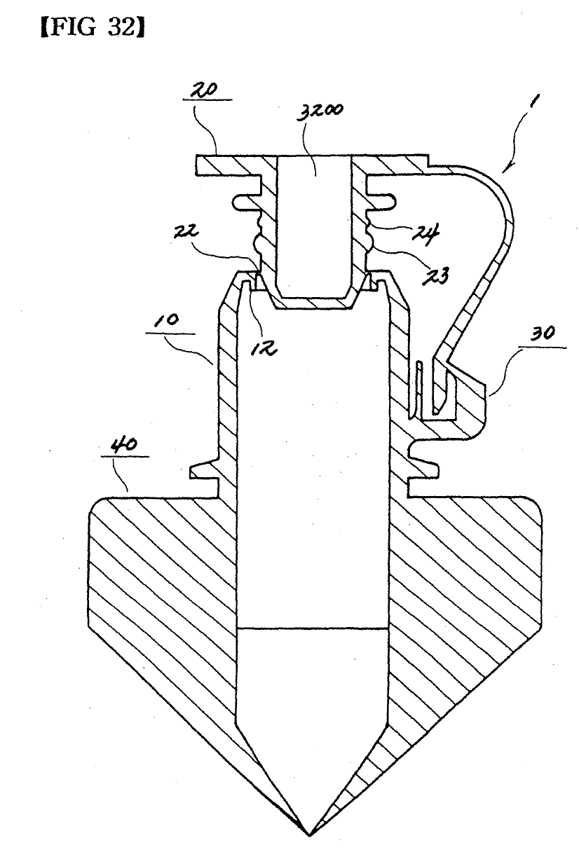

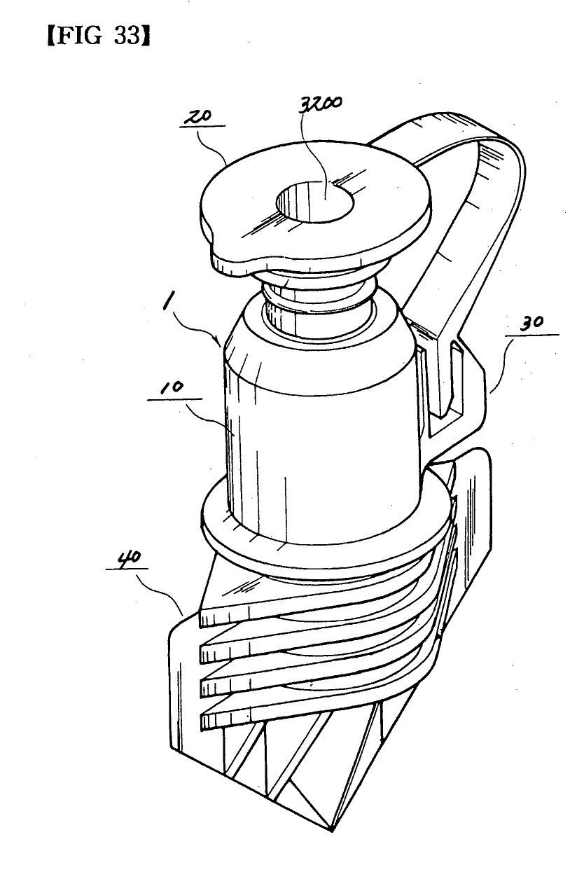

According to a twenty-sixth embodiment of FIGS. 32 and 33, the closure 20 is provided with a space 3200 at its central portion.

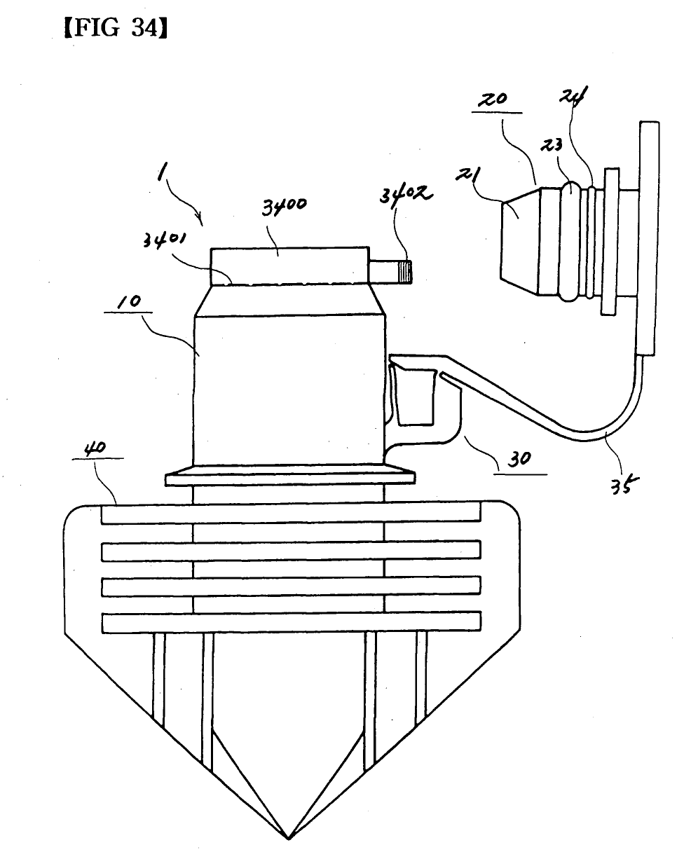

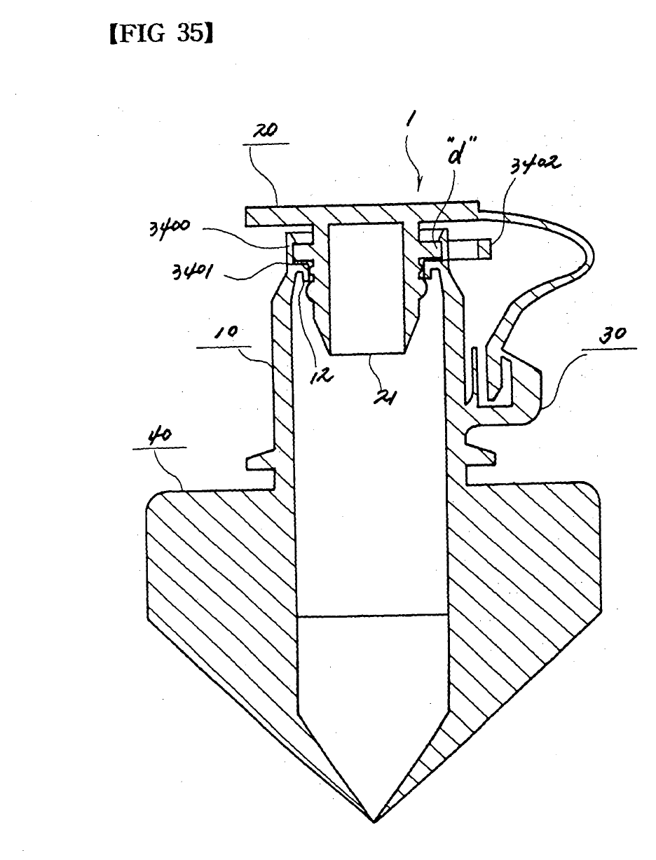

According to a twenty-seventh embodiment of FIGS. 34 and 35, to easily separate the closure 20 from the spouting portion 10, a tamper-proof skirt 3401 with a skirt handle 3402 is formed between the closure 20 and the spouting portion 10. As shown in FIG. 35, a circumference fitting projection d enclosed by the tamper-proof skirt 3400 is formed on the closure 20. Therefore, unless the tamper-proof skirt 3400 is removed, the closure 20 cannot be opened.

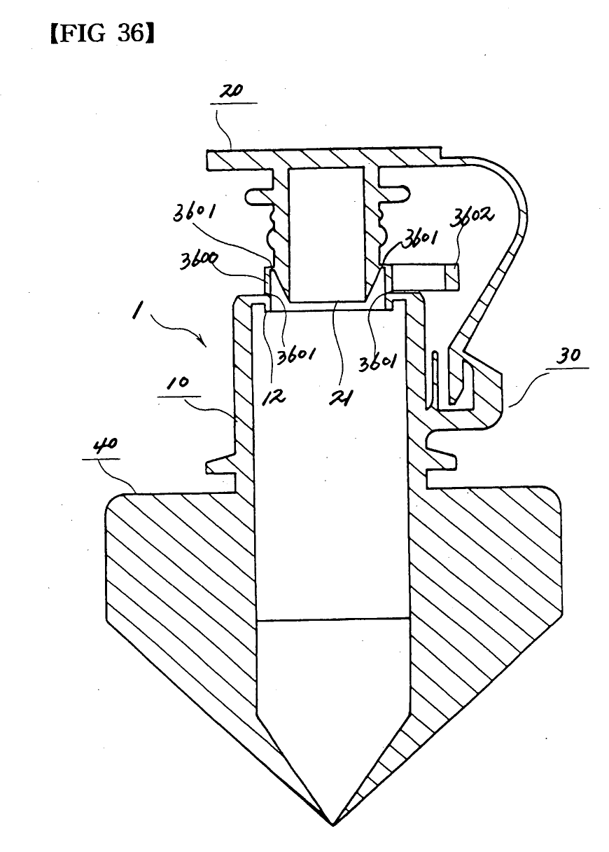

Alternatively, as shown in FIG. 36, the tamper-proof skirt 3600 with the handle 3602 can be formed between the spouting portion 10 and the closure 20 with a cutting line 3601.

Preferably, the tamper-proof skirt 3600 is integrally formed on the elastic projection 12 and the outer circumference of the seal wall 21.

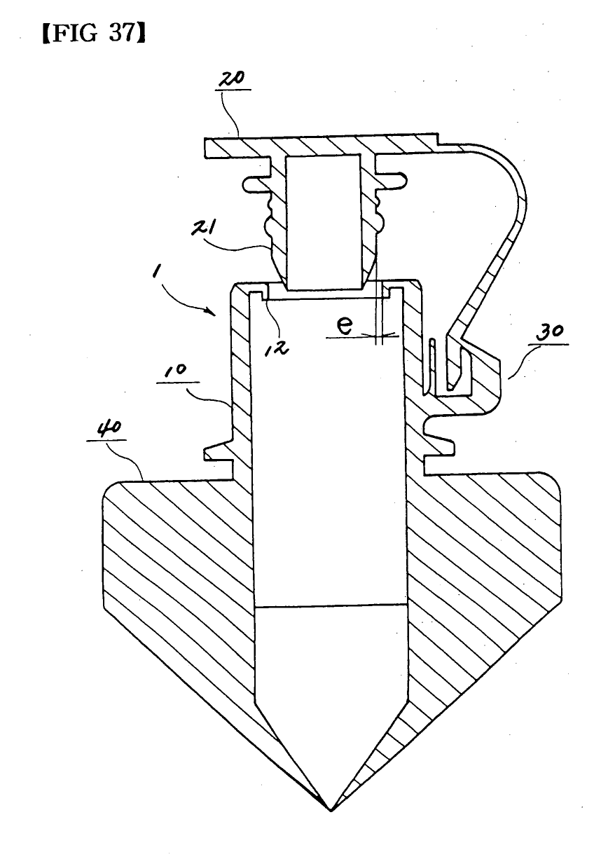

A cutting line 3601 is also formed on the elastic projection 12 and the seal wall so that the skirt 3600 can be easily removed. When the skirt 3600 is removed, as shown in FIG. 37, it is preferable that a gap (e) is maintained between the elastic projection 12 and the seal wall 21.

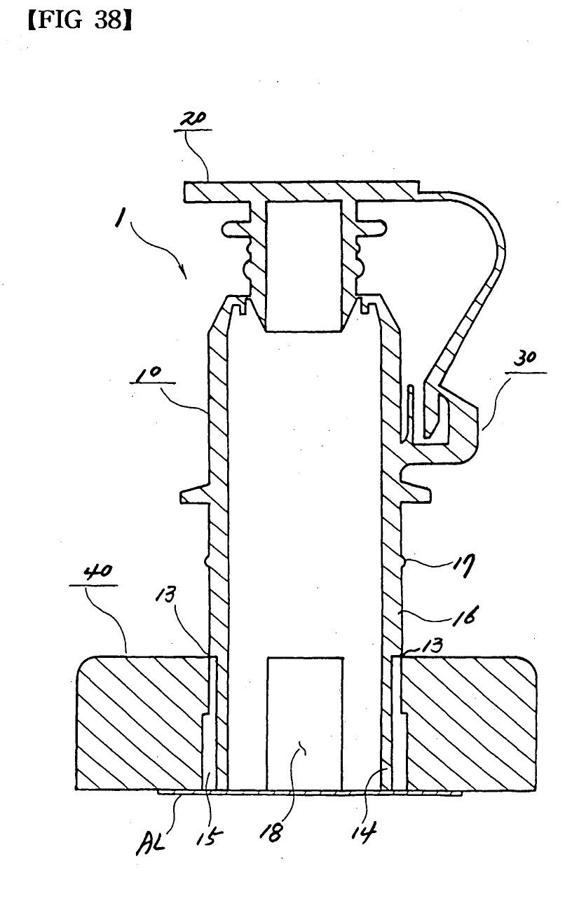

According to a twenty-ninth embodiment of FIG. 38, a punctuation member 14 is formed on a lower end of the spouting portion 10. To this end, a space 15 is defined between the punctuation member 14 and the spout seal portion 40 and a portion of the punctuation member 14 at the upper end of the space 15 is coupled to the spout seal portion 40 by a connecting portion 13.

Preferably, an aluminum film can be attached on the bottom of the spout seal portion 40 to enclose the punctuation 14 and the space 15.

The punctuation member 14 has an operating portion 16 so that the it can move downward by the predetermined force while the connecting portion 13 is broken. The operating portion 16 is provided with a circumferential projection 17 that is interlocked with a step of the spout seal portion 40 so that the movement of the punctuation member 14 can be prevented after it is moved downward. The punctuation member 14 is further provided with at least a fluid passing hole 18.

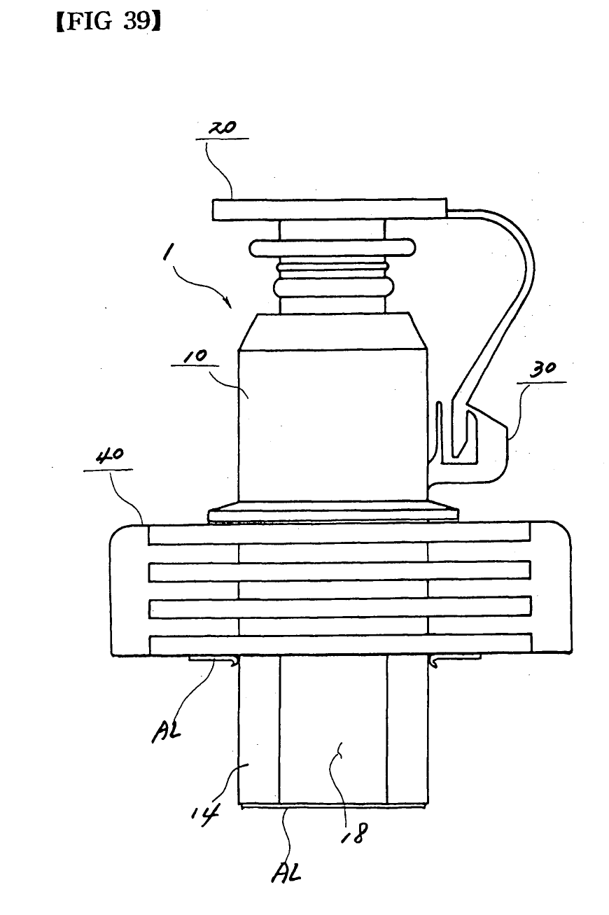

In use, as shown in FIG. 39, when the spouting portion 10 is depressed by the predetermined force, the operating portion 16 is moved downward while breaking the connecting portion 13. The downward movement of the punctuation member 14 is stopped by a stopper formed between the spouting portion 10 and the operating portion 16.

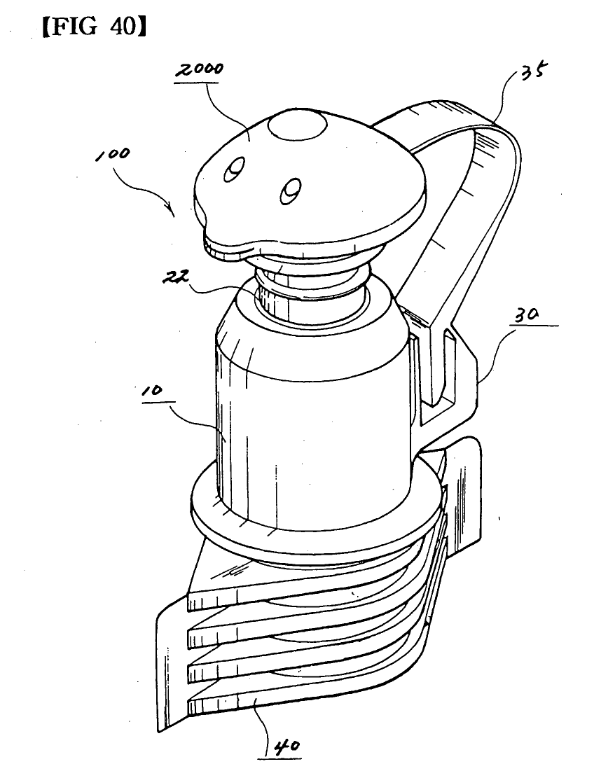

According to a thirties embodiment of FIG. 40, the closure is formed with a specific shape such as a character to represent the characteristics of the products or improve the aesthetic sense.

### INDUSTRICAL APPLICABILITY

As described above, since a spout assembly is designed to be precisely and easily sealed with a container, the productivity is improved. In addition, since the spout assembly is designed having closure location maintaining means that, when it is opened, can maintain the closure at a location where it does not obstruct the flow of contents, the user can more conveniently pour the contents.

1. A spout assembly comprising:
a spout sealing portion coupled on a container sealing portion;
a spouting portion formed on the spouting sealing portion and extending upward;
a closure for closing the spouting portion, the closure being connected to the spouting portion by a connecting member; and
closure location maintaining means for, when the closure is opened, maintaining the closure at a location where the closure does not obstruct the flow of contents discharged through the spouting portion.

2. A spout assembly of claim 1 wherein the closure is integrally formed on the spouting portion with a cutting line between the closure and the spouting portion.

3. A spout assembly of claim 1 wherein the closure location maintaining means comprises a hook member formed on an outer circumference of the spouting portion and a fixing projection formed at one end of the connecting member, the fixing projection being interlocked with the hook member when rotating at a predetermined angle, therein by maintaining the location of the closure at a predetermined position.

4. A spout assembly of claim 3 wherein the hook member comprises a first supporting portion formed on the outer circumference of the spouting member to pivotally support the one end of the connecting member and a second supporting portion for supporting the fixing projection.

5. A spout assembly of claim 4 wherein the second supporting portion is projected upward from the first supporting portion.

6. A spout assembly of claim 4 wherein the second supporting portion is formed of a circumferential groove formed around the spouting portion.

7. A spout assembly of claim 1 wherein the closure location maintaining means comprises a supporting member formed on the spouting portion to pivotally support one end of the connecting member, a fixing projection projected on the supporting member, and a coupling hole formed on the connecting member, the fixing projection being fixedly inserted into the coupling hole.

8. A spout assembly of claim 7 wherein the closure location maintaining means comprises a supporting member pivotally supporting one end of the connecting member, a coupling hole formed on the supporting member, and a fixing projection formed on the connecting member, the fixing projection being fixedly inserted into the coupling hole.

9. A spout assembly of claim 1 wherein the closure location maintaining means comprises a coupling support formed on the spouting portion and a fixing member formed on the connecting member to be fixed on the coupling support.

10. A spout assembly of claim 9 wherein the coupling support is provided with a coupling groove and the fixing member is provided with a fixing projection inserted in the coupling groove.

11. A spout assembly of claim 9 wherein the coupling support is provided with a coupling projection and the fixing member is provided with a fixing groove in which the coupling projection is inserted.

12. A spout assembly of claim 1 wherein the closure location maintaining means comprises first and second coupling portions interlocked with each other, the first and second coupling portions being formed on the connecting member with a pivot connecting portion formed on the connecting member between the first and second coupling portions.

13. A spout assembly of claim 12 wherein the first coupling portion is formed of a fixing projection and the second coupling portion is formed on of a coupling groove in which the fixing projection is inserted.

14. A spout assembly of claim 12 wherein the first coupling portion is formed of a hook projection and the second coupling portion is formed on of a fixing projection interlocked with the hook projection.

15. A spout assembly of claim 1 wherein the closure location maintaining means comprises a fixing projection formed on a top of the closure and a coupling groove formed on the connecting member.

16. A spout assembly of claim 1 wherein a container on which the spout sealing portion is attached is selected from the group consisting of a pouch container, a pet container, a metal container, a glass container, and a carton bag.

17. A spout assembly of claim 1 wherein the spout sealing portion comprises an attaching portion attached on a spout container and an insertion guide portion formed on a bottom of the attaching portion so as to easily locate the attaching portion on the container sealing portion.

18. A spout assembly of claim 17 wherein the insertion guide member is formed such that a width is gradually reduced at it goes downward.

19. A spout assembly of claim 17 wherein a first locating guide portion for guiding the location of opposite ends of the main seal portion on a pouch seal portion defined between films of the pouch container, and a second locating guide portion for guiding the location of the front/rear surfaces of the main seal portion on the pouch seal portion.

20. A spout assembly of claim 19 wherein the first locating guide portion is designed having a width that is gradually reduced as it goes downward, and the second locating guide portion is designed having ribs inclined downward.

21. A spout assembly of claim 1 wherein the closure is formed in a specific character.

22. A spout assembly comprising:
a spout sealing portion coupled on a container sealing portion;
a spouting portion formed on the spouting sealing portion and extending upward; and
a closure for closing the spouting portion, the closure being connected to the spouting portion by a connecting member,
wherein the spout sealing portion comprises an insertion guide portion formed on a bottom of the attaching portion so as to easily locate the spout sealing portion on the container sealing portion.

23. A spout assembly of claim 22 wherein the insertion guide member is formed such that a width is gradually reduced at it goes downward.

24. A spout assembly of claim 22 wherein a first locating guide portion for guiding the location of opposite ends of the main seal portion on a pouch seal portion defined between films of the pouch container, and a second locating guide portion for guiding the location of the front/rear surfaces of the main seal portion on the pouch seal portion.

25. A spout assembly of claim 22 wherein the first locating guide portion is designed having a width that is gradually reduced as it goes downward, and the second locating guide portion is designed having ribs inclined downward.
